(19) United States
(12) Patent Application Publication
(10) Pub. No.: US 2014/0374224 A1
(43) Pub. Date: Dec. 25, 2014

(54) LIMIT SWITCH

(71) Applicants: Manabu Takahashi, Okayama (JP); Kazuyuki Tsukimori, Okayama (JP); Shigenobu Fukui, Tottori (JP)

(72) Inventors: Manabu Takahashi, Okayama (JP); Kazuyuki Tsukimori, Okayama (JP); Shigenobu Fukui, Tottori (JP)

(73) Assignee: OMRON CORPORATION, Kyoto-shi, Kyoto (JP)

(21) Appl. No.: 14/369,038

(22) PCT Filed: Mar. 14, 2012
(86) PCT No.: PCT/JP2012/056528

§ 371 Date: Jul. 24, 2014

(30) Foreign Application Priority Data
Jan. 13, 2012 (JP) 2012-005439

(51) Int. Cl. H01H 3/46; H01H 3/16

(52) U.S. Cl. CPC H01H 3/46; H01H 3/16
USPC 200/47

(57) ABSTRACT

A limit switch has a housing, a plunger that is supported in the housing while being vertically movable, a switch main body disposed in and fixed to the housing by the plunger, an operation shaft having an upper end thereof exposed from a ceiling surface of the switch main body, a contact that is opened and closed by driving the upper end of the operation switch, and a displacement expanding mechanism arranged between the switch main body and the plunger. The displacement expanding mechanism has a pair of pivoting tongue pieces rotatably supported by a pair of support shafts arranged in parallel with each other. A free end of one of the pivoting tongue pieces is abutted on the upper end of the operation shaft. A free end of the other pivoting tongue piece is abutted on an upper surface of one of the pivoting tongue pieces.

### BACKGROUND

1. Technical Field

The present invention relates to a limit switch, particularly to a limit switch having excellent detection sensitivity.

2. Related Art

In some conventional limit switches, for example, as illustrated in FIG. 1 of Patent Document 1, when main shaft 2 and cam 4 rotate by rotation of actuator 3, plunger 6 pushes down activation shaft 7a of built-in switch 7 to open and close a contact of built-in switch 7.

Patent Document 1: Japanese Unexamined Patent Publication No. 11-238430

### SUMMARY

However, in the conventional limit switch, because plunger 6 only pushes down activation shaft 7a of built-in switch 7, a displacement amount is small and detection sensitivity is low.

One or more embodiments of the present invention provides a limit switch having high detection sensitivity.

In accordance with one or more embodiments of the present invention, a limit switch is configured to open and close a contact by driving an upper end of an operation shaft exposed from a ceiling surface of a switch main body accommodated in and fixed to a housing using a plunger that is supported in the housing while being vertically movable. In the limit switch, a displacement expanding mechanism is arranged between the switch main body and the plunger, the displacement expanding mechanism including a pair of pivoting tongue pieces rotatably supported by a pair of support shafts arranged in parallel with each other, in the displacement expanding mechanism, a free end of one of the pivoting tongue pieces being abutted on an upper end of the operation shaft, a free end of the other pivoting tongue piece being abutted on an upper surface of one of the pivoting tongue pieces, and a lower end of the plunger being abutted on the upper surface of one of the pivoting tongue pieces.

According to one or more embodiments of the present invention, because the displacement amount of the plunger can be enlarged by the displacement expanding mechanism and transmitted to the operation shaft of the switch main body, the detection sensitivity of the limit switch is enhanced to obtain the high-sensitivity limit switch.

In accordance with one or more embodiments of the present invention, in the limit switch, the free end of at least one of the pivoting tongue pieces may be folded.

Accordingly, the limit switch having a smoother operating characteristic is obtained because the folded free end comes into line contact with the upper end of the operation shaft or the upper surface of the other pivoting tongue piece.

In accordance with one or more embodiments of the present invention, in the limit switch, the displacement expanding mechanism may be fitted in and fixed to an upper surface of the switch main body.

Accordingly, the assembly work is simplified to obtain the high-productivity limit switch.

In accordance with one or more embodiments of the present invention, in the limit switch, a fixing position of the displacement expanding mechanism may be variable.

Accordingly, the limit switch having a good production yield is advantageously obtained because the position of the displacement expanding mechanism can finely be adjusted even after the assembly.

### BRIEF DESCRIPTION OF THE DRAWINGS

FIGS. 1A and 1B are perspective views illustrating before-and-after action of a limit switch according to a first embodiment of the present invention.

FIG. 2 is an exploded perspective view of the limit switch in FIG. 1.

FIG. 3 is an exploded perspective view of the limit switch in FIG. 1 when viewed from a different angle.

FIGS. 4A and 4B are an enlarged perspective view and a longitudinal sectional view of a switch main body in FIG. 2.

FIG. 5 is an exploded perspective view of a driving mechanism in FIG. 1.

FIG. 6 is an exploded perspective view of the driving mechanism in FIG. 1 when viewed from a different angle.

FIGS. 7A and 7B are perspective views illustrating the before-and-after action of the switch main body in FIG. 4A.

FIG. 8A is a front view of the switch main body in FIG. 4 before the action, FIG. 8B is a sectional view taken along a line B-B of FIG. 8A, and FIG. 8C is a longitudinal sectional view of the switch main body after the action.

FIG. 9A is a front view of a switch main body according to a second embodiment before the action, FIG. 9B is a sectional view taken along a line B-B of FIG. 9A, and FIG. 9C is a longitudinal sectional view of the switch main body after the action.

FIG. 10A is a front view of a switch main body according to a third embodiment before the action, FIG. 10B is a sectional view taken along a line B-B of FIG. 10A, and FIG. 10C is a longitudinal sectional view of the switch main body after the action.

FIG. 11A is a front view of a switch main body according to a fourth embodiment before the action, FIG. 11B is a sectional view taken along a line B-B of FIG. 11A, and FIG. 11C is a longitudinal sectional view of the switch main body after the action.

FIG. 12A is a front view of a switch main body according to a fifth embodiment before the action, FIG. 12B is a sectional view taken along a line B-B of FIG. 12A, and FIG. 12C is a longitudinal sectional view of the switch main body after the action.

### DETAILED DESCRIPTION

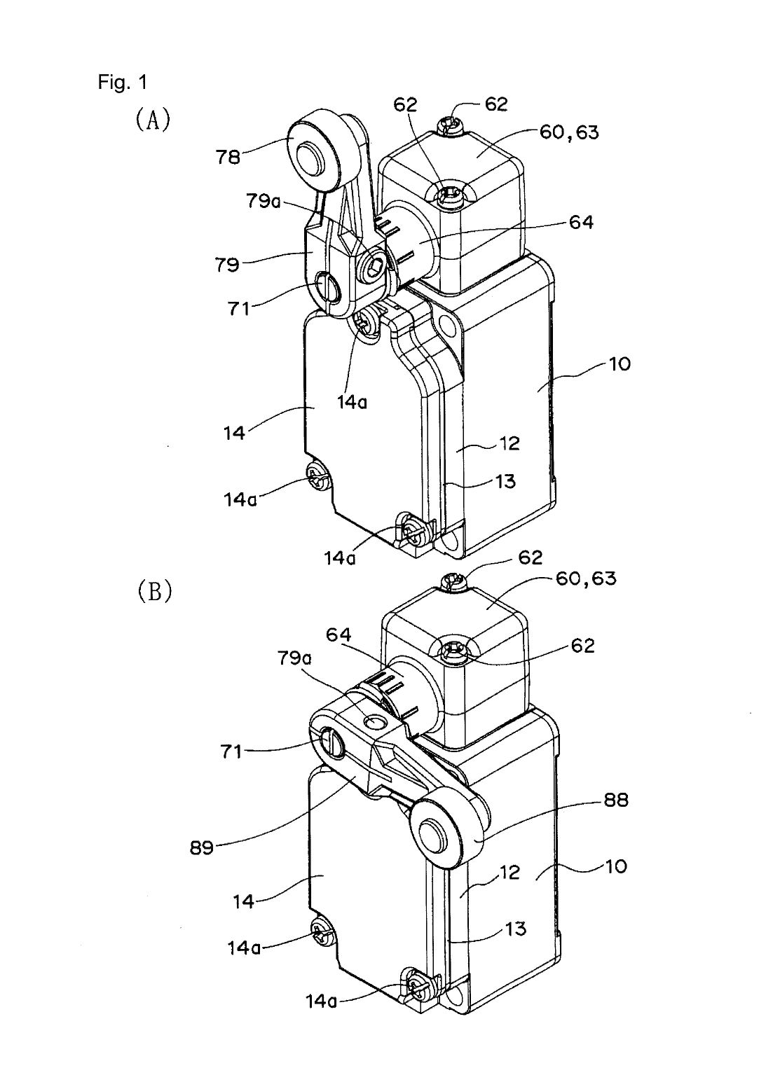

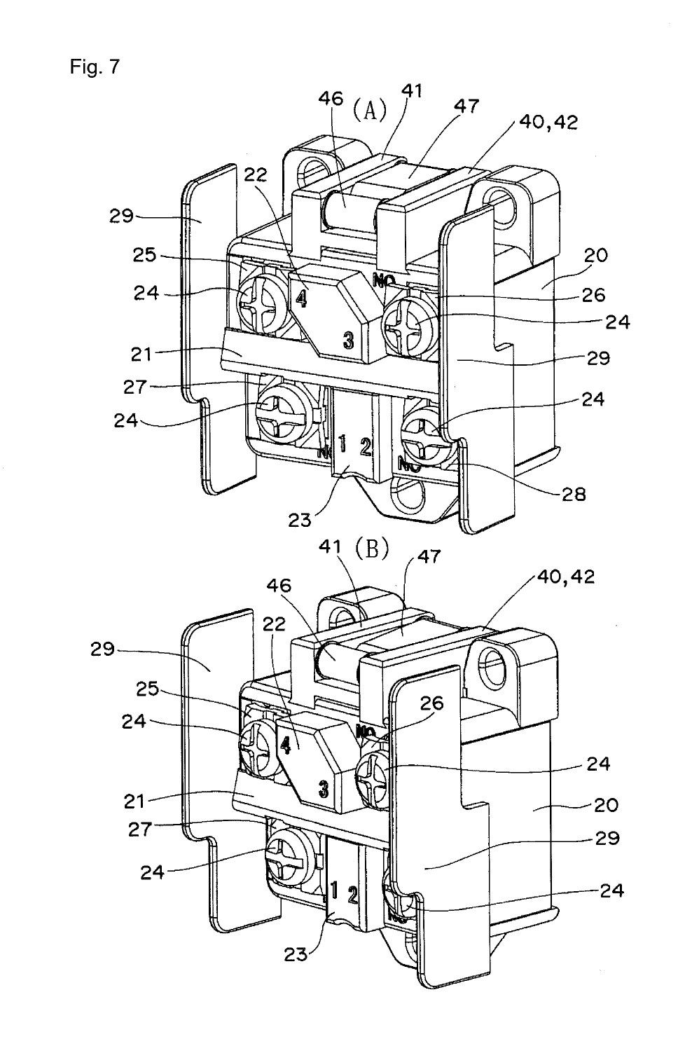

Hereinafter, embodiments of the present invention will be described with reference to FIGS. 1 to 12. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

As illustrated in FIGS. 1 to 8, a limit switch according to a first embodiment includes displacement expanding mechanism 40, and switch main body 20 assembled in housing 10 is driven by driving mechanism 60 including operation lever 79 through plunger 50.

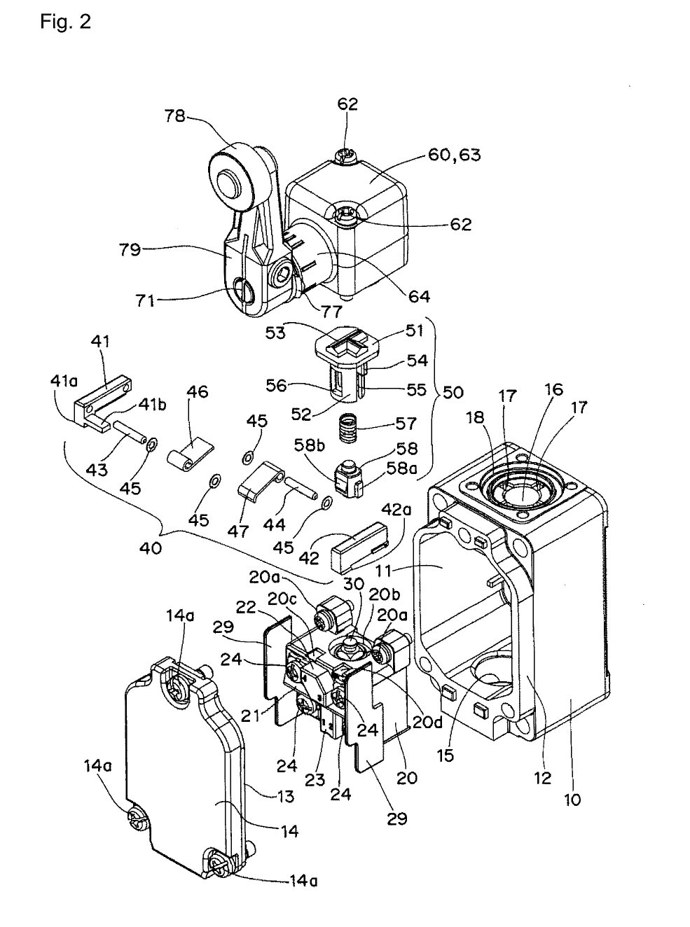

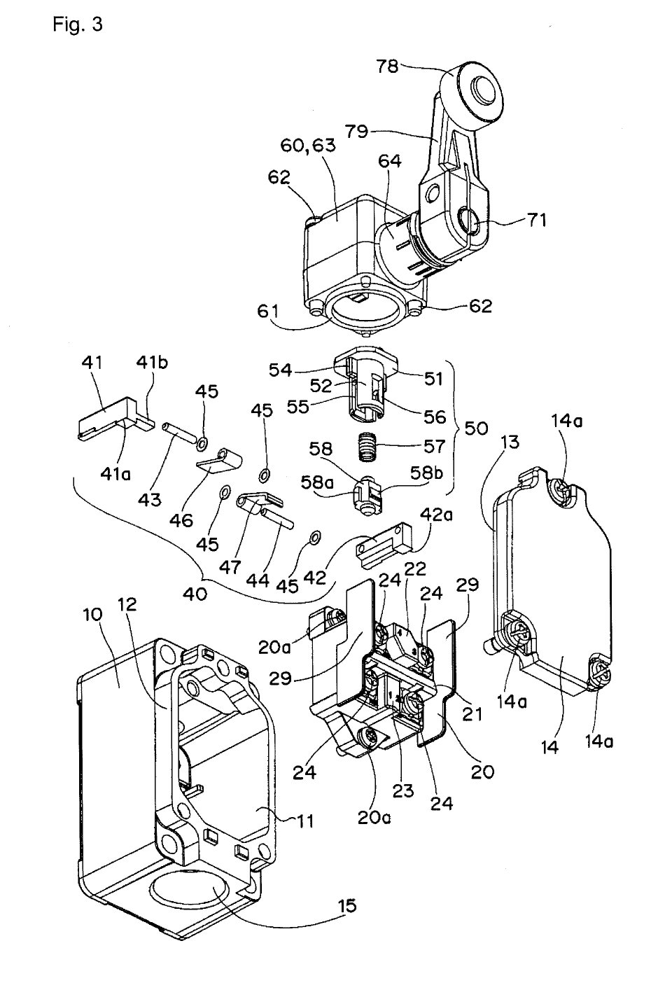

As illustrated in FIGS. 2 and 3, housing 10 has a box shape in which switch main body 20 can be accommodated, and circular rib 12 is formed along opening 11 provided in a front surface of housing 10. Circular seal member 13 is positioned in circular rib 12, and cover 14 is fixed to housing 10 by fixing screws 14a, thereby sealing opening 11. Connection hole 15 is made in a bottom surface of housing 10, and operation hole 16 is made in a ceiling surface of housing 10. Positioning slits 17 are radially formed in an inner circumferential surface of operation hole 16 at intervals of 90 degrees, and circular step 18 is concentrically formed near an opening edge of operation hole 16.

Switch main body 20 has an outer shape of which switch main body 20 can be accommodated from opening 11 of housing 10, and switch main body 20 is fixed to an inside surface of housing 10 by three fixing screws 20a.

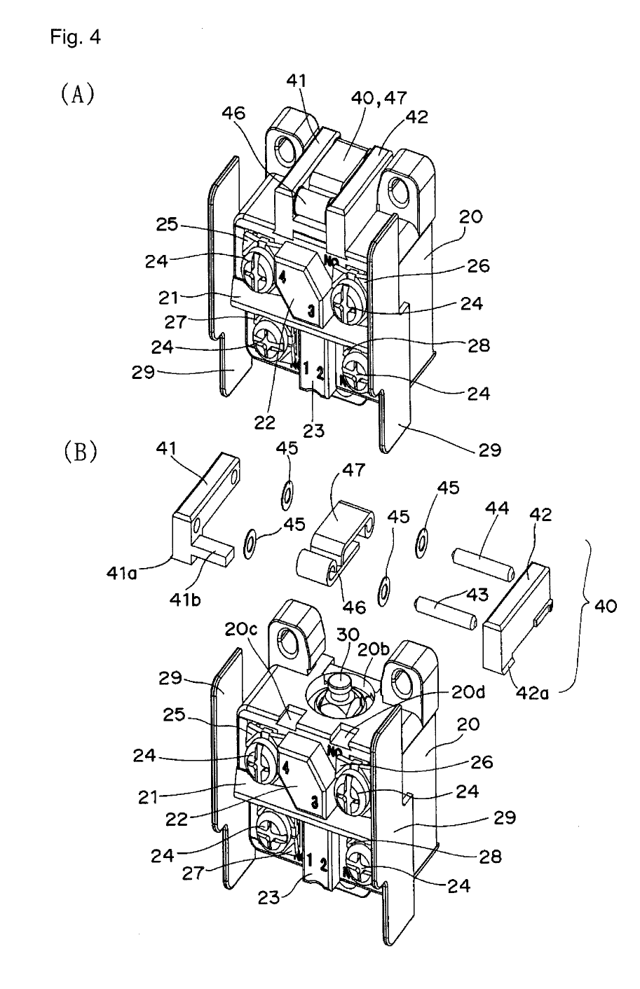

As illustrated in FIG. 4, the front surface of switch main body 20 is vertically partitioned into two stages by partition rib 21, hexagonal first projection 22 is obliquely projected in a center of the upper stage, and square second projection 23 is projected in the center of the lower stage. Fixed contact terminals 25 and 26, each of which includes connection screw 24 and has a substantial U-shape in section, are embedded on both sides of first projection 22, and fixed contact terminals 27 and 28, each of which includes connection screw 24 are embedded on both sides of second projection 23.

Switch main body 20 is provided such that insulating walls 29 and 29 are pushed out onto a front side from end portions on both the sides of switch main body 20.

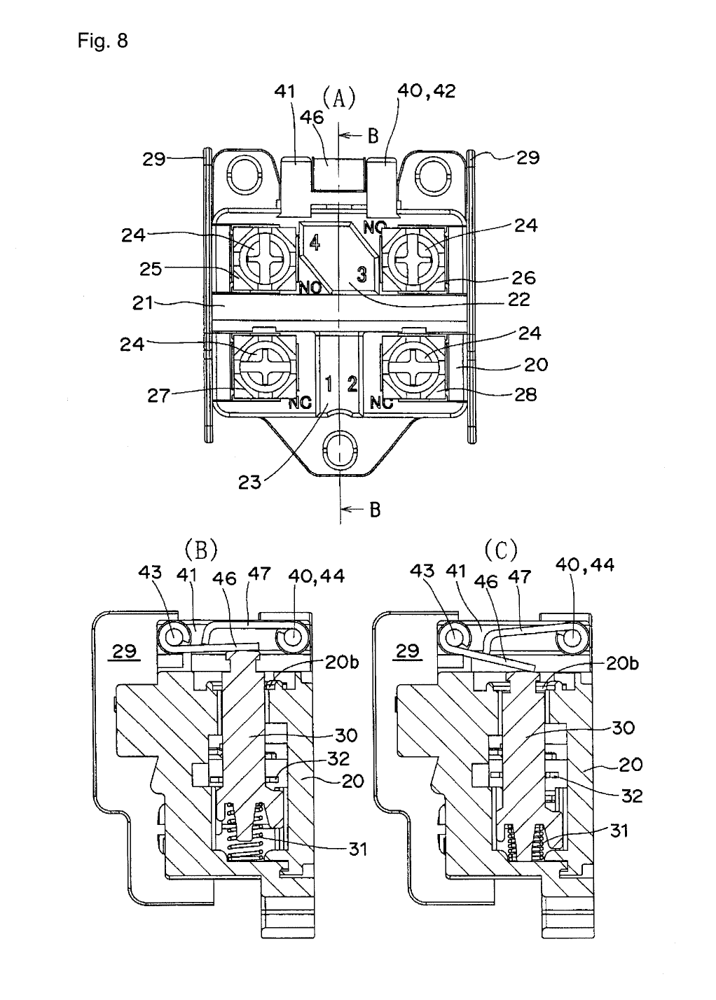

As illustrated in FIG. 8, operation shaft 30 is supported in switch main body 20 while being vertically slidable, and operation shaft 30 is biased upward by coil spring 31. Therefore, an upper end of operation shaft 30 projects from operation hole 20b made in the ceiling surface of switch main body 20. In operation shaft 30, movable touch piece 32 in FIG. 8 is vertically inverted, whereby movable contacts (not illustrated) provided at both ends of movable touch piece 32 alternately come into contact with and separates from fixed contacts of fixed contact terminals 25 and 26 and fixed contacts of fixed contact terminals 27 and 28.

As illustrated in FIG. 4, in displacement expanding mechanism 40, pivoting tongue pieces 46 and 47 are rotatably supported by support shafts 43 and 44 through washers 45. Each of support shafts 43 and 44 is stretched between a pair of support plates 41 and 42 opposed to each other. In displacement expanding mechanism 40, engagement claws 41a and 42a of support plates 41 and 42 are slide-fitted in and fixed to engagement grooves 20c and 20d provided in a ceiling surface of housing 10. Therefore, as illustrated in FIG. 8, a leading end of pivoting tongue piece 46 abuts on an upper end of operation shaft 30, and a bent leading end of pivoting tongue piece 47 abuts on a substantial center of pivoting tongue piece 46. Position regulating projection 41 b (FIG. 4) is provided in support plate 41. The fixing of displacement expanding mechanism 40 is not limited to the slide-fitting. Alternatively, displacement expanding mechanism 40 may be fixed by vertically fitting displacement expanding mechanism 40 with respect to the ceiling surface of housing 10.

As illustrated in FIGS. 2 and 3, plunger 50 has the outer shape that can vertically move along operation hole 16 of housing 10, and cylindrical body 52 is projected from a lower surface of guard portion 51 provided at the upper end of plunger 50. Operating ridge 53 having a substantial T-shape is provided in an upper surface of guard portion 51, and guide rib 54 and slit 55 are collinearly provided in cylindrical body 52, and engagement hole 56 is made in cylindrical body 52. Slide member 58 is fitted in cylindrical body 52 with coil spring 57 interposed therebetween. Slide member 58 includes guide projection 58a engaged with slit 55, and retaining claw 58b engaged with engagement hole 56 is projected from slide member 58.

Guide rib 54 of plunger 50 is selectively fitted in one of positioning slits 17 provided in housing 10, whereby a lower end of slide member 58 assembled in plunger 50 abuts on pivoting tongue piece 47 of displacement expanding mechanism 40. A rotation direction of operation lever 79 which is described later can be detected by pushing down operation shaft 30 through pivoting tongue piece 46.

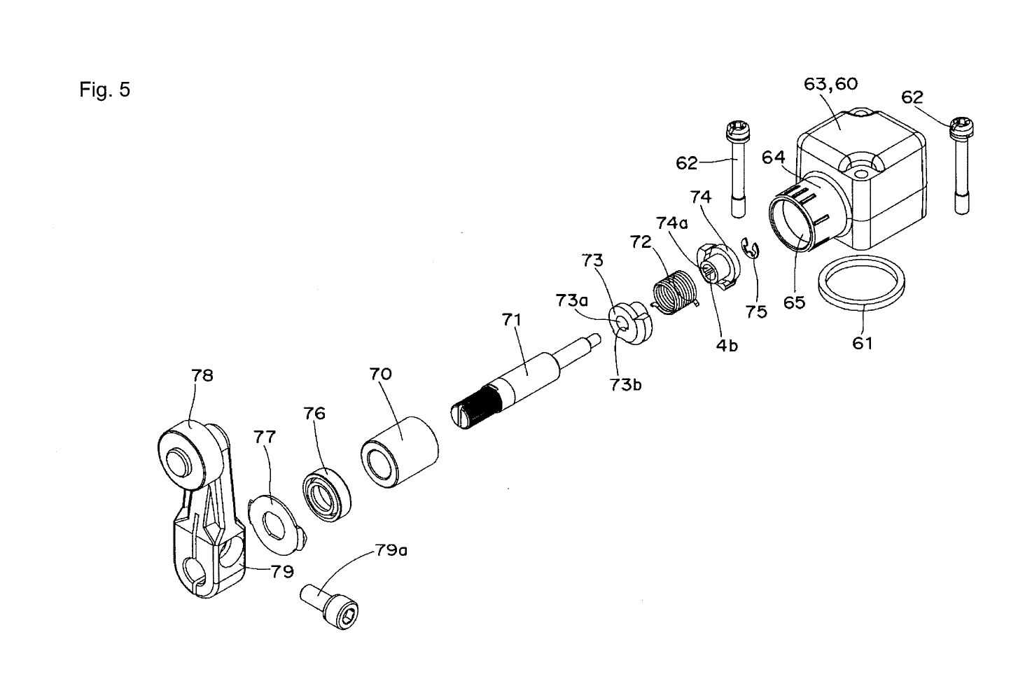

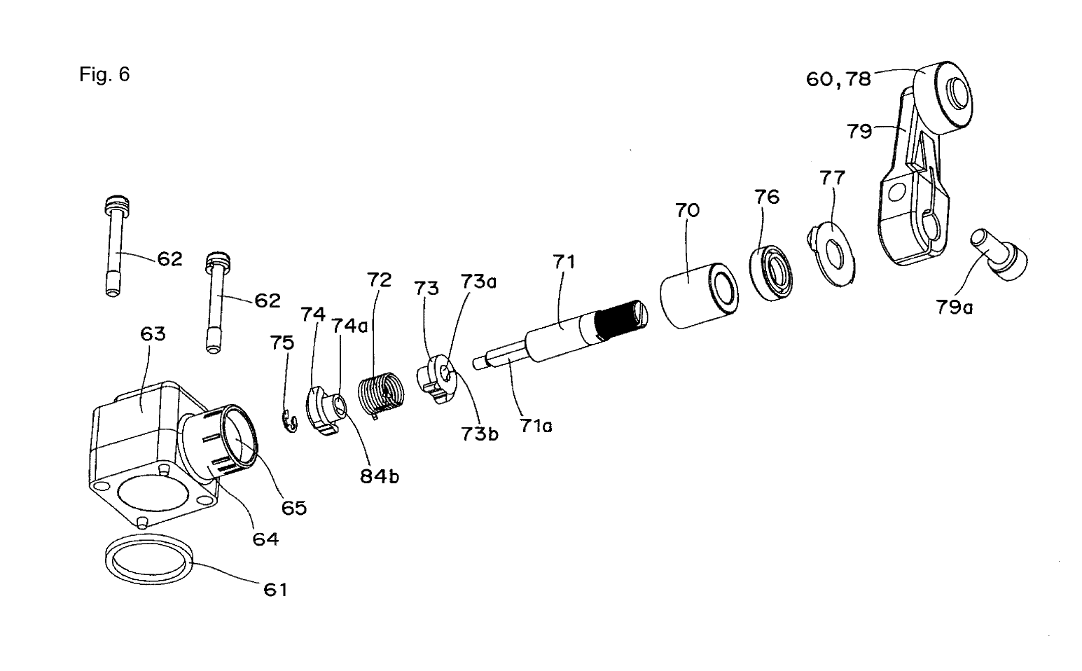

As illustrated in FIGS. 5 and 6, driving mechanism 60 is assembled in box 63 that is fixed to the upper surface of housing 10 with seal ring 61 interposed therebetween by fixing screws 62.

That is, rotating shaft 71 is rotatably inserted in cylindrical bearing section 70 that is press-fixed through attachment hole 65 of cylindrical rib 64 provided in box 63. The leading end of rotating shaft 71 is fitted in a bearing recess (not illustrated) provided in the inside surface of box 63, and a pair of circular cams 73 and 74 sandwiching return coil spring 72 is retained on a leading end side of rotating shaft 71 by E-ring 75.

Particularly, circular cams 73 and 74 include through-holes 73a and 74a that can be fitted in the leading end of rotating shaft 71 in which flat surface 71a (FIG. 6) is provided. Ridges 73b and 74b having a triangular shape in section are projected along a shaft center direction in inner circumferential surfaces of through-holes 73a and 74a, and ridges 73b and 74b can be latched in an edge of flat surface 71a of rotating shaft 71. Both the ends of return coil spring 72 are latched in circular cams 73 and 74 to provide a biasing force in the rotation direction to rotating shaft 71. This is because operation lever 79 which is described later is returned to an original position.

On the other hand, rubber oil seal 76 is mounted on the rear end side of rotating shaft 71 projecting from cylindrical rib 64, and setting position display panel 77 is engaged with the rear end side of rotating shaft 71. Operation lever 79 including roller 78 is fixed to the rear end of rotating shaft 71 by adjustment screw 79a.

A method for assembling the limit switch having the above constituent will be described below.

Switch main body 20 in which displacement expanding mechanism 40 is assembled is inserted from opening 11 of housing 10, and fixed by three fixing screws 20a. Guide rib 54 of plunger 50 is selectively fitted in positioning slit 17 provided in operation hole 16 of housing 10. Seal ring 61 is fitted in circular step 18 provided around operation hole 16, and box 63 is fixed to housing 10 by fixing screws 62.

On the other hand, circular cam 73, return coil spring 72, and circular cam 74 are sequentially inserted on the leading end side of rotating shaft 71, and retained by E-ring 75. Cylindrical bearing section 70 is press-fixed into attachment hole 65 after rotating shaft 71 is inserted from attachment hole 65 of box 63 to fit the leading end of rotating shaft 71 in the bearing recess (not illustrated) provided in the inside surface of box 63. Therefore, cylindrical bearing section 70 abuts on an outward surface of circular cam 73 to retain rotating shaft 71. At this point, circular cams 73 and 74 abut on operating ridge 53 of plunger 50. Rubber oil seal 76 is fitted on the rear end side of rotating shaft 71 projecting from box 63, whereby setting position display panel 77 is engaged while the sealing is performed. Then operation lever 79 is attached to the rear end of rotating shaft 71, and fixed by adjustment screw 79a.

After circular seal member 13 is positioned in circular rib 12 of housing 10, cover 14 is fixed by fixing screws 14a to complete the assembly work.

In the case that lead wires are connected to switch main body 20 on site, after cover 14 is detached, connection terminals of the lead wires (not illustrated) are fixed to fixed contact terminals 27 and 28 on the lower stage side by connection screws 24. Then the connection terminal of the lead wire (not illustrated) is fixed to fixed contact terminal 26 by connection screw 24. Finally, the lead wire (not illustrated) is fixed to fixed contact terminal 25 by connection screw 24 to complete the connection work.

According to the first embodiment, a creeping distance is lengthened by partition rib 21, and first and second projections 22 and 23 act as the insulating wall. Therefore, the limit switch having an excellent insulating characteristic is obtained.

In the case that the connection is performed by a connection structure different from the above-described connection structure, the lead wire may be detoured along first projection 22 and connected to fixed contact terminal 26.

According to the first embodiment, an outer circumferential surface of first projection 22 has a shape along a wiring route of the lead wire, so that advantageously the connection work can efficiently be performed.

Action of the limit switch of the first embodiment will be described below. In the case that an external force is not applied to operation lever 79 as illustrated in FIG. 1, operation lever 79 is vertically provided and only the pair of circular cams 73 and 74 of driving mechanism 60 abuts on operating ridge 53 of plunger 50, but circular cams 73 and 74 do not push down plunger 50.

Therefore, operation shaft 30 is pushed up by a spring force of coil spring 31, the movable contact (not illustrated) provided at both ends of movable touch piece 32 is in contact with fixed contact terminals 25 and 26.

When operation lever 79 rotates clockwise by the external force, the edge on one side of flat surface 71 a provided in rotating shaft 71 is latched in ridge 73a of circular cam 73. Only circular cam 73 rotates, operating ridge 53 of plunger 50 is pushed down to compress coil spring 57, and slide member 58 is lowered to push down pivoting tongue piece 47. As a result, pivoting tongue piece 46 is pushed down by a principle of leverage, and operation shaft 30 is pushed down. Movable touch piece 32 is pushed down and inverted, whereby the movable contact provided in movable touch piece 32 is switched from fixed contact terminals 25 and 26 to fixed contact terminals 27 and 28.

When the external force is released, rotating shaft 71 rotates in the opposite direction by the spring force of return coil spring 72, operation lever 79 returns to the original position, and operation shaft 30 and plunger 50 are pushed up by the spring force of coil spring 31.

On the other hand, when operation lever 79 rotates counterclockwise by the external force, the edge on the other side of flat surface 71 a provided in rotating shaft 71 is latched in ridge 74a of circular cam 74. Only circular cam 74 rotates, operating ridge 53 of plunger 50 is pushed down to compress coil spring 57, and slide member 58 is lowered to push down pivoting tongue piece 47. As a result, pivoting tongue piece 46 is pushed down by a principle of leverage, and operation shaft 30 is pushed down. Movable touch piece 32 is pushed down and inverted, whereby the movable contact provided in movable touch piece 32 is switched from fixed contact terminals 25 and 26 to fixed contact terminals 27 and 28.

When the external load is released, rotating shaft 71 rotates in the opposite direction by the spring force of return coil spring 72, operation lever 79 returns to the original position, and operation shaft 30 and plunger 50 are pushed up by the spring force of coil spring 31.

In the first embodiment, guide rib 54 is engaged with selected positioning slit 17 when plunger 50 is assembled in housing 10. Therefore, for example, the clockwise external force can be detected while the counterclockwise external force is not detected.

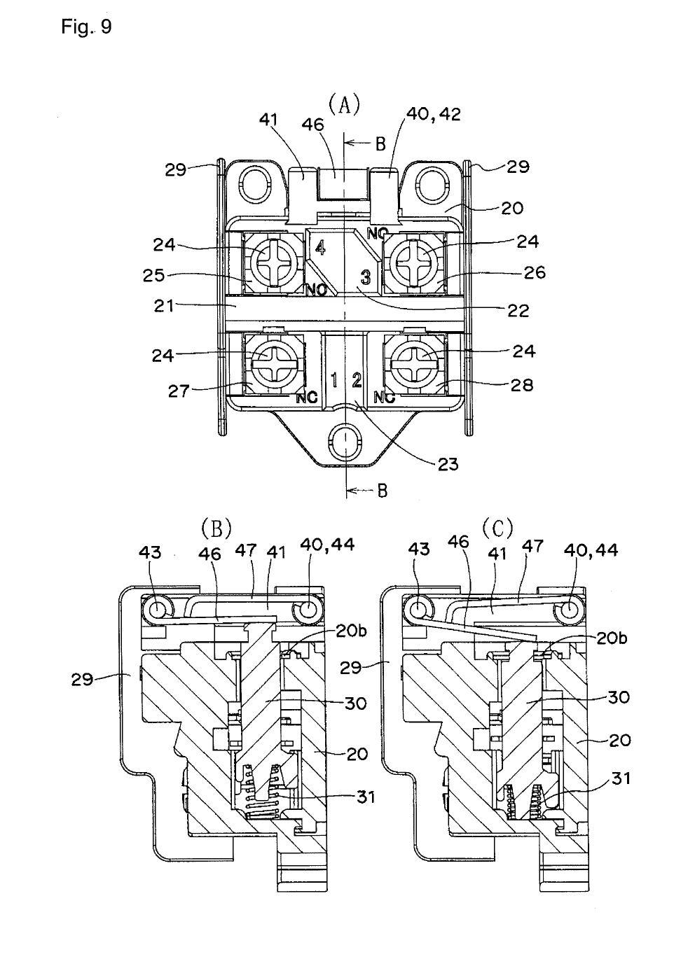

In a second embodiment, as illustrated in FIG. 9, a ratio of the leverage is increased by lengthening pivoting tongue pieces 46 and 47, whereby larger operation force and operation amount can be secured. Because other configurations of the second embodiment are similar to those of the first embodiment, the same component is designated by the same numeral, and the description is omitted.

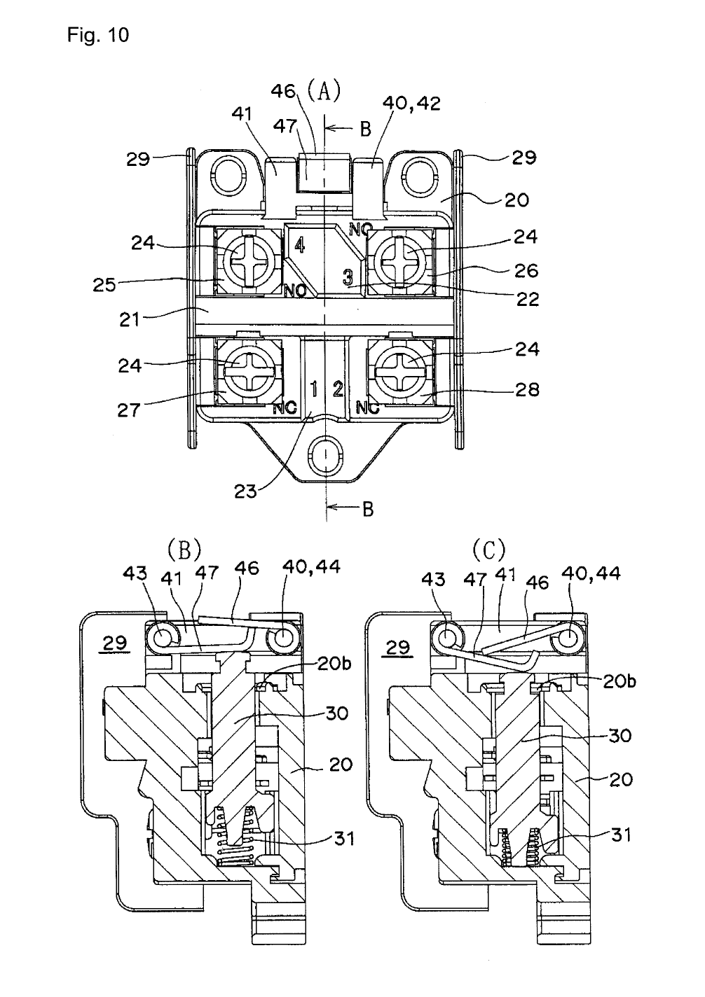

In a third embodiment, as illustrated in FIG. 10, the larger operation amount can be secured by changing attachment positions of pivoting tongue pieces 46 and 47 of the first embodiment. Because the ratio of the leverage can be changed only by changing the attachment position, usability is improved and a component is easy to manage.

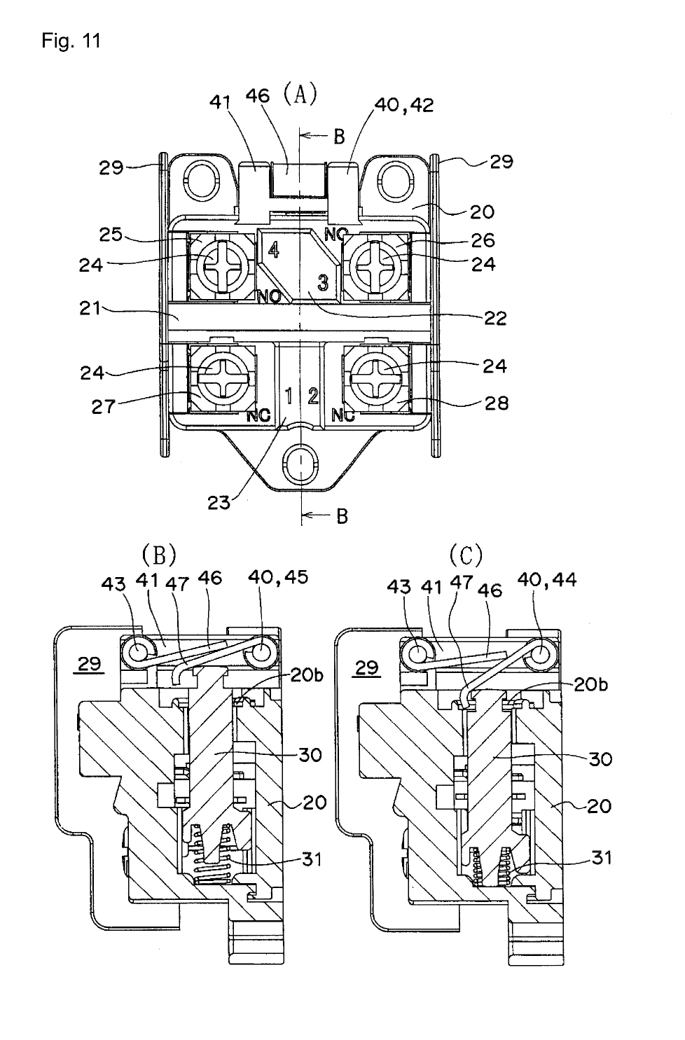

In a fourth embodiment, the vertical positions of pivoting tongue pieces 46 and 47 of the first embodiment are changed as illustrated in FIG. 11. Because the ratio of the leverage can be changed only by changing the vertical position, the usability is improved and the component is easy to manage.

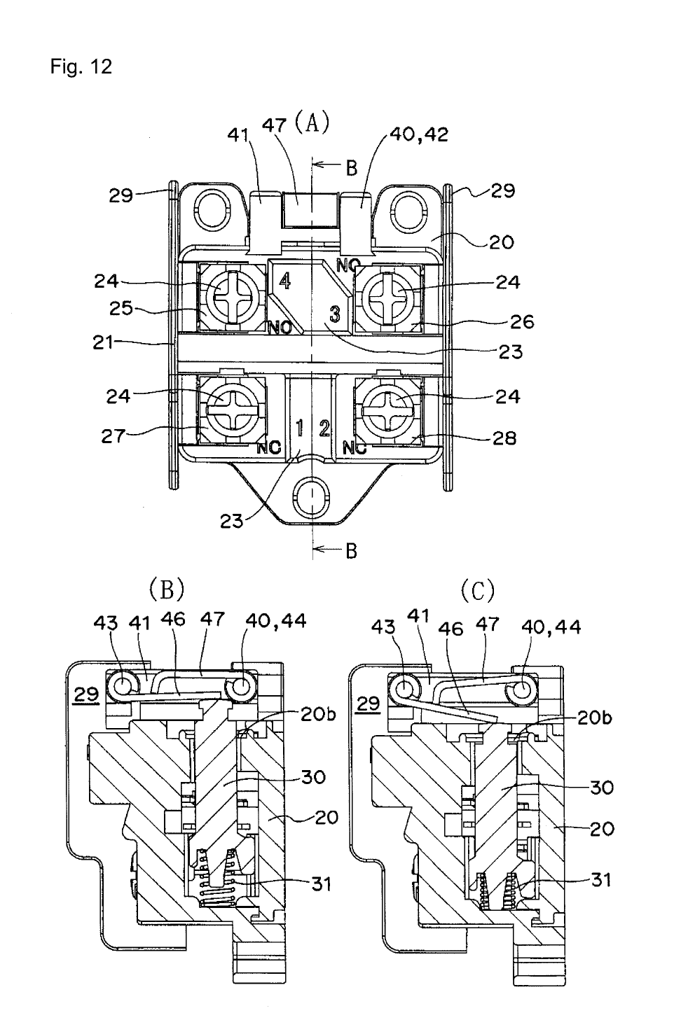

In a fifth embodiment, as illustrated in FIG. 12, the ratio of the leverage can be changed by bringing the position of operation shaft 30 close to support shaft 44 without changing the attachment positions and outer dimensions of pivoting tongue pieces 46 and 47 of the first embodiment.

As is clear from the fourth embodiment, because the ratio of the leverage can be changed without changing the shapes of pivoting tongue pieces 46 and 47, a degree of design freedom is advantageously increased.

Although not illustrated, the fixing position of displacement expanding mechanism 40 may be varied when engagement claws 41a and 42a provided in support plates 41 and 42 of displacement expanding mechanism 40 are fixed to engagement grooves 20c and 20d provided in the ceiling surface of housing 10 by the slide-fitting. When the fixing position of the displacement expanding mechanism 40 is varied, advantageously the ratio of the leverage can finely be adjusted even after the assembly to improve a production yield.

For the same reason, a position adjusting elongated hole may be used as a screw hole through which switch main body 20 is fixed by fixing screw 20a.

The operation lever is not necessarily attached in the vertical direction. For example, the operation lever may be attached in a horizontal or oblique direction.

In one or more of the embodiments, the four lead wires are connected to the limit switch by way of example. Alternatively, for example, six or eight lead wires may be connected to the limit switch.

Only one circular cam may be attached to the rotating shaft.

One or more embodiments of the present invention can be applied to not only the limit switch but also limit switches having other shapes.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF SYMBOLS

10: housing

11: opening

14: cover

15: connection hole

16: operation hole

20: switch main body

21: partition rib

22: first projection

23: second projection

24: connection screw

25, 26, 27, 28: fixed contact terminal

29: insulating wall

30: operation shaft

31: coil spring

40: displacement expanding mechanism

41, 42: support plate

43, 44: support shaft

46, 47: pivoting tongue piece

50: plunger

51: guard portion

52: cylindrical body

53: operating ridge

54: guide rib

57: coil spring

58: slide member

60: driving mechanism

61: seal ring

62: fixing screw

63: box

64: cylindrical rib

65: attachment hole

70: cylindrical bearing section

71: rotating shaft

71a: flat surface

72: return coil spring

73, 74: circular cam

75: E-ring

76: oil seal

77: setting position display panel

78: roller

79: operation lever

1. A limit switch comprising:
a housing;
a plunger that is supported in the housing while being vertically movable;
a switch main body disposed in and fixed to the housing by the plunger;
an operation shaft having an upper end thereof exposed from a ceiling surface of the switch main body;
a contact that is opened and closed by driving the upper end of the operation switch; and
a displacement expanding mechanism arranged between the switch main body and the plunger,
wherein the displacement expanding mechanism comprises:
a pair of pivoting tongue pieces rotatably supported by a pair of support shafts arranged in parallel with each other,
wherein a free end of one of the pivoting tongue pieces is abutted on the upper end of the operation shaft,
wherein a free end of the other pivoting tongue piece is abutted on an upper surface of one of the pivoting tongue pieces, and
wherein a lower end of the plunger is abutted on the upper surface of one of the pivoting tongue pieces.

2. The limit switch according to claim 1, wherein the free end of at least one of the pivoting tongue pieces is folded.

3. The limit switch according to claim 1, wherein the displacement expanding mechanism is fitted in and fixed to an upper surface of the switch main body.

4. The limit switch according to claim 3, wherein a fixing position of the displacement expanding mechanism is variable.

5. The limit switch according to claim 2, wherein the displacement expanding mechanism is fitted in and fixed to an upper surface of the switch main body.

6. The limit switch according to claim 5, wherein a fixing position of the displacement expanding mechanism is variable.
